(19) United States
(12) Patent Application Publication
(10) Pub. No.: US 2026/0121879 A1
(43) Pub. Date: Apr. 30, 2026

(54) TENANT IDENTIFIER CORRELATION TO RESOURCE USAGE

(71) Applicant: HEWLETT PACKARD ENTERPRISE DEVELOPMENT LP, Spring, TX (US)

(72) Inventors: Christopher Snell, Fountain Inn, SC (US); Tejaswi Rajeevalochanam, Bangalore (IN); Ayub Uddin N, Bangalore (IN); Abhay Padlia, Bangalore (IN); Dipratna Sukhadeve, Bangalore (IN); Navneeth Nalinakshan, Mississauga (CA)

(21) Appl. No.: 18/931,275

(22) Filed: Oct. 30, 2024

(51) Int. Cl. H04L 12/14; H04L 43/065

(52) U.S. Cl. CPC H04L 12/1432; H04L 12/1403; H04L 43/065

(57) ABSTRACT

In some examples, as part of onboarding a tenant to a computing environment, a tenant identifier is generated for the tenant. The tenant identifier is added to metadata of a management service for the computing environment. A metering service tracks metric data relating to resource usage by the tenant in the computing environment. The metering service creates a resource usage record including attributes, where the attributes include an attribute containing the metric data, and an attribute containing the tenant identifier. The management service correlates the tenant identifier in the metadata to the tenant identifier in the resource usage record. The management service performs a management action for the tenant based on the resource usage record.

### BACKGROUND

Computing environments may be set up to perform respective workloads associated with different entities, such as different groups of users, different business units of an organization, and so forth. In some examples, computing environments are provided in a cloud, and the computing environments are accessible by tenants of the cloud. In other examples, computing environments are deployed on premises of an organization.

### BRIEF DESCRIPTION OF THE DRAWINGS

Some implementations of the present disclosure are described with respect to the following figures.

FIG. 1 is a block diagram of an arrangement including a computing environment and a management service for the computing environment, in accordance with some examples.

FIG. 2 is a flow diagram of a process of a tenant management controller, a resource usage metering controller, and a management service, according to some examples.

FIG. 3 is a block diagram of a storage medium storing machine-readable instructions according to some examples.

FIG. 4 is a block diagram of a system according to some examples.

FIG. 5 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Due to security requirements, some computing environments are deployed, operated, and updated without connections to services accessible over public networks (e.g., the Internet). Such computing environments may be referred to as “disconnected” computing environments. In contrast, a computing environment that has a connection to a service accessible over a public network is referred to as a “connected” computing environment.

Tools that may be available to connected computing environments may not be available to disconnected computing environments. An example of such a tool is a dedicated metering service that can collect tenant-specific metrics relating to usage of resources of a connected computing environment by a tenant of the connected computing environment. The connected computing environment can have multiple tenants, which are entities (e.g., users, groups of users, programs, or machines) with access to use resources of the connected computing environment. The dedicated metering service that can collect tenant-specific resource usage metrics for an individual tenant allows for management actions to be applied for the individual tenant based on the tenant's resource usage metrics.

In contrast, in a disconnected computing environment, resource usage metrics may be collected without distinguishing between multiple tenants of the disconnected computing environment. As a result, a management service would not be able to determine which portion of the collected resource usage metrics are attributable to an individual tenant, and the management service would be unable to perform tenant-specific management actions based on the resource usage metrics attributable to the individual tenant.

In accordance with some implementations of the present disclosure, systems or techniques add a tenant identifier created during onboarding of a tenant to (1) a resource usage record containing metric data for the tenant, and (2) metadata of a management service. Based on the tenant identifier in the resource usage record, the management service can determine which tenant the metric data in the resource usage record is associated with. The management service is aware of the tenant identifier because the tenant identifier has been added to the metadata of the management service. The management service can perform a management action for the tenant based on the resource usage record.

The tenant identifier is created as part of onboarding the tenant in a computing environment, such as a disconnected computing environment. A metering service of the computing environment generates resource usage records that include tenant identifier tags for identifying respective tenants, where a tenant identifier tag in a resource usage record includes a tenant identifier of an individual tenant. Each resource usage record includes metric data relating to usage of one or more resources of the computing environment. In some examples of the present disclosure, after the tenant identifier of a tenant is created during onboarding of the tenant, the tenant identifier is added to the metadata of the management service. The metadata can be part of a configuration database or other data repository associated with the management service. When processing a given resource usage record, the management service can correlate the tenant identifier in the metadata to the tenant identifier in the given resource usage record. The management service can then perform a management action for the tenant in the cloud environment based on the given resource usage record.

Systems or techniques according to some examples of the present disclosure allows the management service to distinguish between resource usage records for different tenants so that the management service is able to use tenant-specific management actions. Tenant identifiers used during onboarding of tenants can be used to correlate activities of the tenants across different platforms, including a computing environment platform that deploys a computing environment, and a management platform that deploys the management service.

A “computing environment” can refer to a cloud environment operated by a cloud service provider, a data center operated by a data center owner, or any other type of computing environment. In some examples, the computing environment can be a disconnected computing environment. In other examples, the computing environment can be a connected computing environment.

A “resource usage record” can refer to any data structure containing metric data associated with a tenant's use of resource(s) of the computing environment. The resource usage record can be in the form of a file, an entry of a table, an object, or any other data structure. A tenant identifier can include a name, an alphanumeric string, a numeric value, or any other information that distinguishes one tenant from another tenant.

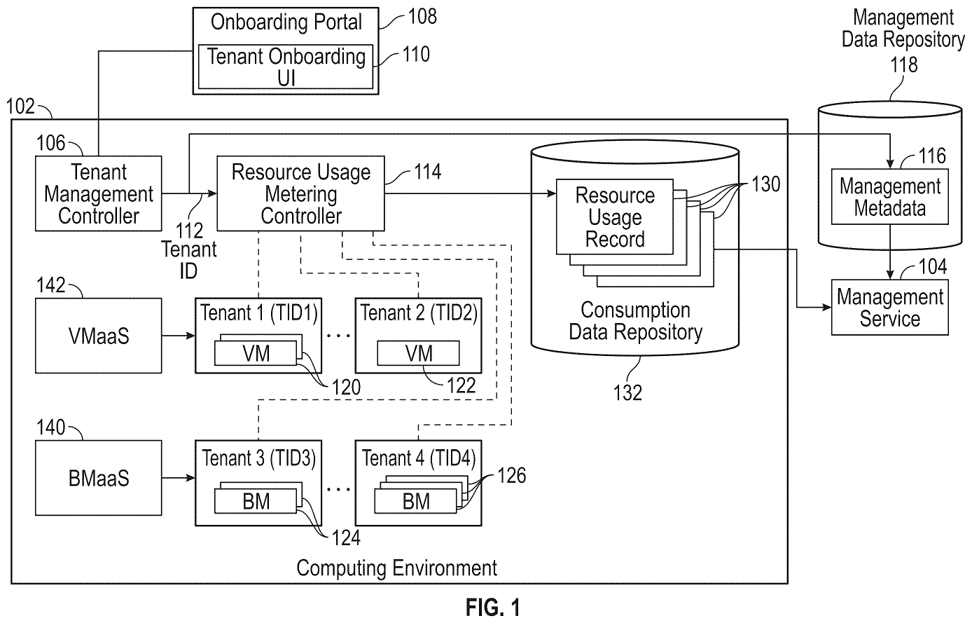

FIG. 1 is a block diagram of an example arrangement that includes a computing environment 102 and a management service 104 that is able to perform tenant-specific management actions for tenants of the computing environment 102 (and possibly other computing environments). In some examples, a first vendor that provides the platform (including software and possibly infrastructure) for deploying the management service 104 can be different from a second vendor that provides the platform (including software and possibly infrastructure) for deploying the computing environment 102. In other examples, the first vendor and the second vendor may be the same.

In the example shown in FIG. 1, the management service 104 is outside the computing environment 102. In alternative examples, the management service 104 may be included in the computing environment 102. Although shown as a singular component, the management service 104 in some examples may include services provided by multiple programs from different vendors or from the same vendor.

Tenant-specific management actions of the management service 104 can include any or some combination of the following: capacity planning that determines how much resource capacity (of the computing environment 102) is to be assigned to a tenant to perform workloads of the tenant that meet a performance goal; resource allocation to dynamically increase or decrease resources of the computing environment 102 for the tenant due to changing conditions of workloads; sprawl reduction to reduce the sprawl of virtual machines (VMs) or other virtual compute entities (e.g., containers) for the tenant; workload migration to move workloads across different physical resources in the computing environment 102 to enhance efficiency and reduce energy usage; billing to generate an invoice to the tenant for use of resources of the computing environment 102; or other management actions. The reduction of sprawl of VMs can include terminating VMs that are no longer used by the tenant or to move VMs to consolidate VMs onto fewer computing nodes. Sprawl of VMs refers to VMs of the tenant being spread across a large quantity of computing nodes, which may result in inefficient use of resources.

The computing environment 102 includes a tenant management controller 106 that is used to onboard tenants for the computing environment 102. “Onboarding” a tenant refers to registering the tenant to allow the tenant to use resources of the computing environment 102. A tenant that has not been onboarded would not be able to use the resources of the computing environment 102. A “tenant” can refer to a user, a group of users, an organization (e.g., a company, an educational organization, a government agency, etc.), a unit within an organization (e.g., a business unit, a department, etc.), or any other entity (including a program or a machine) that is able to request use of the resources of the computing environment 102.

Note that in some cases, a “tenant” can also include a management tenant that manages the computing environment 102. A management tenant can be different from other tenants that use resources of the computing environment 102 for production operations of the tenants. Resource usage by management tenants can be distinguished from resource usage of other tenants, since the management tenants are assigned respective distinct tenant identifiers.

The resources of the computing environment 102 that are accessible to tenants can include any or some combination of the following: physical resources, virtual resources, programs, services, or any other resources. Physical resources can include any or some combination of the following: a processing resource, a storage resource, or a communication resource.

In the example of FIG. 1, physical resources of the computing environment 102 that are available to tenants include physical resources of a bare-metal (BM) as a service (BMaaS) 140. The BMaaS 140 allows tenants to request bare-metal (BM) servers to use for executing workloads of the tenants. A “bare-metal server” or “BM server” can refer to a collection of physical resources that is available to the tenant. For example, a BM server can include a central processing unit (CPU) including one or more hardware processors, a memory, a communication interface, a storage drive, and so forth. Different BM servers may have different capacities (e.g., different compute capacities, different memory capacities, different communication capabilities, etc.). For example, a first BM server may have a CPU with a larger quantity of hardware processors than a CPU of a second BM server. As another example, different BM servers may have memories of different sizes, or network interface controllers of different communication bandwidths. As further examples, some BM servers may include graphics processing units (GPUs), neural processing units (NPUs), tensor processing units (TPUs), or other types of accelerators that are not present in other BM servers.

As further shown in FIG. 1, virtual resources of the computing environment 102 that are available to tenants include VMs provided by a VM as a service (VMaaS) 142. The VMaaS 142 allows a tenant to request use of one or more VMs to perform workloads of the tenant. A VM is an example of a virtual compute entity that can be executed using physical resources of the computing environment 102. A VM can include a virtual memory, a virtual central processing unit (vCPU), an operating system (OS), and other components, such as components relating to backing up data, components relating to performing security functions, and so forth.

In other examples, instead of or in addition to offering the BMaaS 140 and the VMaaS 142, the computing environment 102 can also offer other types of services, such as containers, application programs, storage services, communication services, and so forth.

The tenant management controller 106 presents an onboarding portal 108 that are accessible to users (e.g., administrators or other users) seeking to onboard tenants. The onboarding portal 108 may be accessible through an application programming interface (API), a website, or another type of interface. Users can employ client devices to access the onboarding portal 108. Examples of client devices include any or some combination of the following: a desktop computer, a notebook computer, a tablet computer, a smartphone, or another electronic device.

A tenant onboarding user interface (UI) 110 of the onboarding portal 108 can be presented at a client device. In some examples, the tenant onboarding UI 110 includes a graphic user interface (GUI) containing control elements and fields selectable by a user to onboard a tenant to the computing environment 102. In other examples, the tenant onboarding UI 110 includes a command line interface (CLI) through which a user can issue commands to onboard a tenant to the computing environment 102.

In response to an onboarding request received from the tenant onboarding UI 110, the tenant management controller 106 onboards a tenant to the computing environment 102. The tenant management controller 106 generates a tenant identifier (ID) 112 for the onboarded tenant. The tenant management controller 106 can provide the tenant ID 112 to a resource usage metering controller 114 of the computing environment 102.

Additionally, the tenant management controller 106 can add the tenant ID 112 to management metadata 116 that is associated with the management service 104. The management metadata 116 is stored in a data repository 118, such as a database (e.g., a configuration management database or CMDB) or another type of data repository. The management metadata 116 contains information that is used by the management service 104 to provide various management actions. The inclusion of tenant IDs in the management metadata 116 allows the management service 104 to be aware of tenants that have been onboarded to the computing environment 102 so that the management service 104 can perform tenant-specific management actions for the tenants.

The tenant management controller 106 may become aware of the management service 104 once the management service 104 is registered with the tenant management controller 106. Registering the management service 104 with the tenant management controller 106 can include adding information identifying a location of the management metadata 116. The location of the management metadata 116 may be specified by a uniform resource locator (URL), a storage address, a database table name, or any other type of location information. Tenant IDs of tenants can be added by the tenant management controller 106 after the registration process has been performed to register the management service 104 with the tenant management controller 106.

In the example of FIG. 1, four tenants 1 to 4 have been onboarded. Tenant 1 is assigned tenant ID TID1, tenant 2 is assigned tenant ID TID2, tenant 3 is assigned tenant ID TID3, and tenant 4 is assigned tenant ID TID4. Although four tenants are shown in FIG. 1, in other examples, a different quantity of tenants may be onboarded to the computing environment 102.

In some examples, the onboarding portal 108 or another administrative portal can be used to request an allocation of resources for a tenant. The tenant management controller 106 receives the request to the allocation of resources, and in response, allocates the requested resources (including resources of the VMaaS 142 or the BMaaS 140) to the tenant. In the example of FIG. 1, tenant 1 has been allocated VMs 120 from the VMaaS 142, and tenant 2 has been allocated VM 122 from the VMaaS 142. Tenant 3 has been allocated BM servers 124, and tenant 4 has been allocated BM servers 126. The resources allocated to respective tenants are used to execute the tenants' workloads.

The resource usage metering controller 114 is able to monitor usage of resources used by each tenant. In some examples, the tenant management controller 106 has assigned tenant 1 with tenant ID TID 1, tenant 2 with tenant ID TID 2, tenant 3 with TID 3, and tenant 4 with tenant ID TID 4. The foregoing tenant IDs were provided by the tenant management controller 106 to the resource usage metering controller 114, and has been added to the metadata 116 of the management service 104.

The resource usage metering controller 114 is able to collect various metrics associated with use of resources (including VMs and BM servers) of the computing environment 102 by tenants. Metrics associated with use of a VM can include any or some combination of the following: a metric relating to use of a virtual CPU (vCPU) of the VM (e.g., how many vCPUs used), a metric relating to use of a virtual memory of the VM (e.g., the memory space of the virtual memory used), a metric relating to use of a virtual storage at the VM (e.g., the storage space of the virtual storage used), or a metric relating to use of another feature of the VM. Metrics associated with use of a BM server can include any or some combination of the following: a metric relating to use of processors of a physical CPU of the BM server (e.g., how many processors used, such a quantity of processor cores of the physical CPU), a metric relating to use of a physical memory of the of the BM server (e.g., the memory space of the physical memory used), a metric relating to use of accelerators of the BM server (e.g., how many accelerators such as GPUs, NPUs, TPUs, etc., used), or a metric relating to use of another feature of the BM server.

Although some example metrics are listed, in other examples, the resource usage metering controller 114 can collect alternative or additional metrics relating to use of resources of the computing environment 102 by tenants. The metrics are collected into resource usage records 130 that are stored in a consumption data repository 132, which can be a database or another type of data repository. In some examples, a resource usage record 130 may be in the form of a file, such as a JavaScript Object Notation (JSON) file. In other examples, a resource usage record 130 may be in the form of a text file, an entry of a table, or any other data structure. Each resource usage record 130 contains information for an individual tenant. Different tenants are associated with different resource usage records 130. In some cases, multiple resource usage records 130 may be collected for a given tenant.

In some examples, a resource usage record 130 for a tenant that uses a collection of VMs may include attributes listed in Table 1 below. A “collection” of items can refer to a single item or multiple items. Thus, a collection of VMs can refer to a single VM or multiple VMs. Although some example attributes are listed in Table 1, in other examples, alternative or additional attributes may be included in a resource usage record 130 for usage of the collection of VMs.

TABLE 1

| Attribute | Description |
|---|---|
| Resource.name | Name(s) of a VM or multiple VMs in the |
| | collection of VMs |
| Resource.tag.tenantID | Tenant ID of a tenant using the |
| | collection of VMs |
| Resource.type | Type of VM(s) |
| Usage.start | Start timestamp of metered time |
| | duration |
| Usage.end | End timestamp of metered time duration |
| Usage.meters.id | An ID for the metered object |
| Usage.meters.qty | A quantity of the metered object used |
| | during the metered time duration |
| . . . | . . . |

The Usage.start attribute defines the start time of a metered time duration, and the Usage.end attribute defines the end time of the metered time duration. The metered time duration is the duration during which usage of resources is monitored. For example, the metered time duration may be a 24-hour duration, a 1-hour duration, an N-minutes duration, a 1-week duration, or any other time duration.

The Usage.meters.id attribute includes an ID of a metered object, which in the example of Table 1 is a metric relating to use of a feature of a VM, such as a vCPU, a virtual memory, a virtual storage, and so forth. The ID can include a globally unique identifier (GUID) or another type of ID. The Usage.meters.qty attribute includes a value representing how much of the VM feature represented by the Usage.meters.id attribute is used by the tenant represented by the tenant ID in the Resource.tag.tenantID attribute. There may be multiple instances of each of the Usage.meters.id attribute and the Usage.meters.qty for respective metrics of different features of the VM used by the tenant.

The Resource.name attribute includes the name(s) of the VM(s) of the collection of VMs allocated to the tenant. The Resource.type attribute indicates a type of the VM(s) allocated to the tenant.

In some examples, a resource usage record 130 for a tenant that uses a collection of BM servers may include attributes listed in Table 2 below. Although some example attributes are listed in Table 2, in other examples, alternative or additional attributes may be included in a resource usage record 130 for usage of the collection of BM servers.

TABLE 2

| Attribute | Description |
|---|---|
| Resource.tags.MachineID | ID(s) of BM server(s) in the collection of |
| | BM servers |
| Resource.tags.SerialNumber | Serial number(s) of BM server(s) in the |
| | collection of BM servers |
| Resource.tag.tenantID | Tenant ID of a tenant using the |
| | collection of BM servers |
| Resource.type | Type of BM server(s) |
| Usage.start | Start timestamp of metered time |
| | duration |
| Usage.end | End timestamp of metered time duration |
| Usage.meters.id | An ID for the metered object |
| Usage.meters.qty | A quantity of the metered object used |
| | during the metered time duration |
| . . . | . . . |

The Usage.meters.id attribute includes an ID of a metered object, which in the example of Table 2 is a metric relating to use of a feature of a BM server, such as a physical CPU, a physical memory, a physical storage, an accelerator, and so forth. The ID can include a GUID or another type of ID. The Usage.meters.qty attribute includes a value representing how much of the BM server feature represented by the Usage.meters.id attribute is used by the tenant represented by the tenant ID in the Resource.tag.tenantID attribute. There may be multiple instances of each of the Usage.meters.id attribute and the Usage.meters.qty for respective metrics of different features of the BM server used by the tenant.

The resource usage records 130 added to the consumption data repository 132 by the resource usage metering controller 114 are available to the management service 104. The management service 104 can retrieve the resource usage records 130 over a network or through an interface (e.g., an API). The management service 104 may periodically poll the consumption data repository 132 for newly added resource usage records 130. Alternatively, the management service 104 may access the consumption data repository 132 to retrieve newly added resource usage records 130 in response to a notification from the computing environment 102.

In other examples, the resource usage metering controller 114 or a different entity of the computing environment 102 can push resource usage records 130 to the management service 104 as the resource usage records 130 are added to the consumption data repository 132 or on a periodic basis.

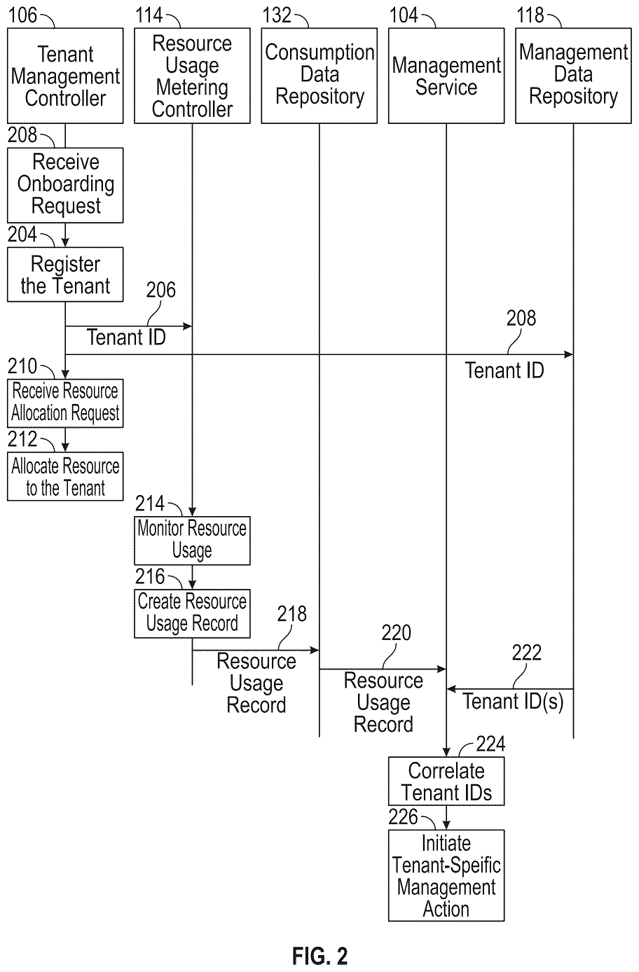

FIG. 2 is a flow diagram of a process of the tenant management controller 106, the resource usage metering controller 114, and the management service 104, according to some examples of the present disclosure.

The tenant management controller 106 receives (at 202) an onboarding request to onboard a tenant. In response to the onboarding request, the tenant management controller 106 registers (at 204) the tenant to the computing environment 102. The registration of the tenant includes generating a tenant ID of the tenant.

The tenant management controller 106 sends (at 206) the tenant ID to the resource usage metering controller 114. Additionally, the tenant management controller 106 adds (at 208) the tenant ID to the management metadata 116 associated with the management service. In some examples, the tenant management controller 106 can add the tenant ID to the management metadata 116 by accessing an API associated with the management data repository 118. In other examples, the tenant management controller 106 can add the tenant ID to the management metadata 116 by using another type of request, such as a Hypertext Transfer Protocol (HTTP) request or another request, to the management data repository 118.

The tenant management controller 106 receives (at 210) a resource allocation request to allocate resources of the computing environment 102 to the tenant. In response to the resource allocation request, the tenant management controller 106 allocates (at 212) resources to the tenant. The allocated resources can include a collection of VMs or a collection of BM servers, for example.

The resource usage metering controller 114 monitors (at 214) usage of the allocated resources during a metered time duration. Based on the monitored usage, the resource usage metering controller 114 creates (at 216) a resource usage record 130 that includes attributes relating to use of the allocated resources by the tenant. Examples of the attributes are listed in Table 1 or 2. The tenant management controller 106 adds (at 218) the resource usage record 130 to the consumption data repository 132.

The management service 104 obtains (at 220) the resource usage record 130 from the consumption data repository 132. The management service 104 also retrieves (at 222) any tenant ID(s) in the management metadata 116.

The management service 104 correlates (at 224) the tenant ID in the resource usage record 130 to a matching tenant ID previously added to the management metadata 116. Note that if the matching tenant ID is not present in management metadata 116, then the management service 104 would decline to perform any management action for the tenant identified in the resource usage record 130. However, if the management service 104 is able to correlate the tenant ID in the resource usage record 130 to the matching tenant ID in the management metadata 116, the management service 104 can initiate (at 226) performance of a tenant-specific management action for the tenant based on the metrics included in the resource usage record 130.

Note that in further examples, the management service 104 can trigger tenant-specific management actions for the tenant based on multiple resource usage records 130 from the consumption data repository 132.

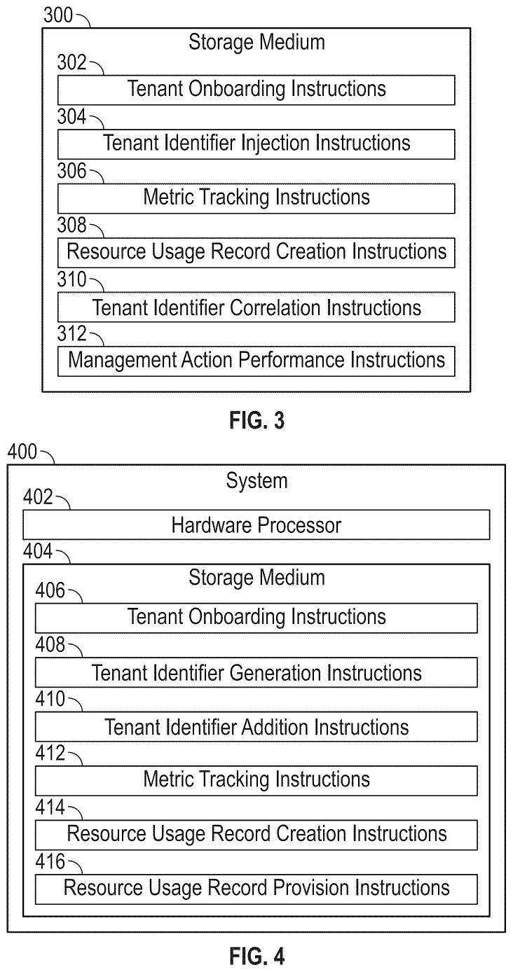

FIG. 3 is a block diagram of a non-transitory machine-readable or computer-readable storage medium 300 storing machine-readable instructions that upon execution cause a system to perform various tasks. The system includes one or more computers.

The machine-readable instructions include tenant onboarding instructions 302 to, as part of onboarding a tenant to a computing environment, generate a tenant ID for the tenant. The tenant onboarding instructions 302 may be part of the tenant management controller 106 of FIG. 1, for example.

The machine-readable instructions include tenant identifier injection instructions 304 to add the tenant ID to metadata of a management service for the computing environment. An example of the management service is the management service 104 of FIG. 1. The tenant identifier injection instructions 304 may be part of the tenant management controller 106 of FIG. 1, for example.

The machine-readable instructions include metric tracking instructions 306 to track, with a metering service of the computing environment, metric data relating to resource usage by the tenant in the computing environment. The resource usage can include usage of one or more of virtual resources or physical resources.

The machine-readable instructions include resource usage record creation instructions 308 to create, by the metering service, a resource usage record including attributes. The attributes including an attribute containing the metric data, and an attribute containing the tenant ID. An example of the metering service is the resource usage metering controller 114 of FIG. 1.

The machine-readable instructions include tenant identifier correlation instructions 310 to correlate, by the management service, the tenant ID in the metadata to the tenant ID in the resource usage record. Correlating the tenant IDs includes checking to ensure that the tenant ID in the resource usage record matches a tenant ID in the metadata before the management service allows a management action to be performed based on the resource usage record.

The machine-readable instructions include management action performance instructions 312 to perform, with the management service, a management action for the tenant based on the resource usage record.

In some examples, the computing environment is a disconnected cloud environment.

In some examples, the management service is separate from the computing environment and does not interact directly with a tenant management controller of the computing environment. Stated differently, no interface exists between the management service and the tenant management controller so that the management service is unable to directly receive information from the tenant management controller.

In some examples, the management service is provided by a first vendor that is different from a second vendor providing a computing environment platform deploying the computing environment.

In some examples, the machine-readable instructions can add the tenant identifier to the metadata of the management service after completion of a registration process to register the management service with a tenant management controller of the computing environment.

In some examples, the machine-readable instructions can track, with the metering service of the computing environment, further metric data relating to resource usage by a further tenant in the computing environment. The machine-readable instructions can create, by the metering service, a further resource usage record comprising attributes, the attributes of the further resource usage record comprising an attribute containing the further metric data, and an attribute containing a tenant identifier of the further tenant.

In some examples, the resource usage record includes time information (e.g., in the form of start timestamp and an end timestamp) identifying a time interval over which the metric data is collected.

In some examples, the resource usage record includes information indicating a type of a resource used by the tenant. The type of resource indicate can include a virtual resource (e.g., a VM) or a physical resource (e.g., a BM server).

FIG. 4 is a block diagram of a system 400 according to some examples. The system 400 includes a hardware processor 402 (or multiple hardware processors). A hardware processor can include a microprocessor, a core of a multi-core microprocessor, a microcontroller, a programmable integrated circuit, a programmable gate array, or another hardware processing circuit.

The system 400 includes a storage medium 404 storing machine-readable instructions executable on the hardware processor 402 to perform various tasks. Machine-readable instructions executable on a hardware processor can refer to the instructions executable on a single hardware processor or the instructions executable on multiple hardware processors.

The machine-readable instructions in the storage medium 404 include tenant onboarding instructions 406 to onboard a tenant to a computing environment. A tenant onboarded to the computing environment has access to resources of the computing environment.

The machine-readable instructions in the storage medium 404 include tenant identifier generation instructions 408 to generate a tenant ID for the tenant as part of the onboarding. The tenant ID for the tenant is unique to the tenant in the computing environment.

The machine-readable instructions in the storage medium 404 include tenant identifier addition instructions 410 to add the tenant ID to management metadata of a management service for the computing environment. An example of the management metadata is the management metadata 116 of FIG. 1.

The machine-readable instructions in the storage medium 404 include metric tracking instructions 412 to track metric data relating to resource usage by the tenant in the computing environment. Resources that can be used include virtual resources or physical resources.

The machine-readable instructions in the storage medium 404 include resource usage record creation instructions 414 to create a resource usage record including attributes. The attributes include an attribute containing the metric data, and an attribute containing the tenant identifier.

The machine-readable instructions in the storage medium 404 include resource usage record provision instructions 416 to provide the resource usage record to the management service for use by the management service in initiating a management action based on the tenant identifier added to the management metadata and the tenant identifier in the resource usage record.

In some examples, the machine-readable instructions can provide an onboarding portal (e.g., 108 in FIG. 1) accessible by a user to request the onboarding of the tenant to the computing environment.

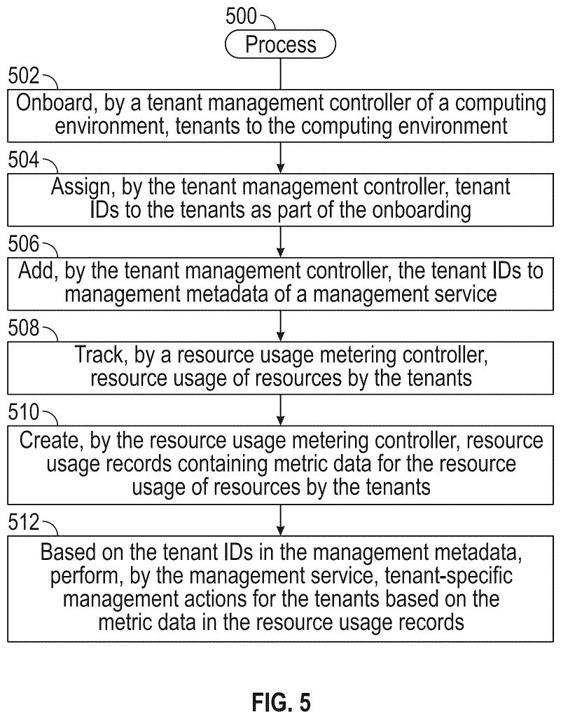

FIG. 5 is a flow diagram of a process 500 according to some examples of the present disclosure. The process 500 may be performed by one or more computers.

The process 500 includes onboarding (at 502), by a tenant management controller of a computing environment, tenants to the computing environment. The onboarded tenants are able to use services offered by the computing environment.

The process 500 includes assigning (at 504), by the tenant management controller, tenant IDs to the tenants as part of the onboarding. Different tenants are assigned different tenant IDs.

The process 500 includes adding (at 506), by the tenant management controller, the tenant IDs to management metadata of a management service. Adding the tenant IDs to the management metadata allows the management service to become aware of the tenant IDs without the management service having to interact directly with the tenant management controller.

The process 500 includes tracking (at 508), by a resource usage metering controller, resource usage of resources by the tenants.

The process 500 includes creating (at 510), by the resource usage metering controller, resource usage records containing metric data for the resource usage of resources by the tenants. Each respective resource usage record of the resource usage records includes a tenant ID identifying a tenant that the respective resource usage record is associated with.

Based on the tenant IDs in the management metadata, the process 500 includes performing (at 512), by the management service, tenant-specific management actions for the tenants based on the metric data in the resource usage records.

A data repository can be stored in one or more storage devices, such as disk-based storage devices, solid-state drives, or other types of storage devices. A “controller” can refer to one or more hardware processing circuits, which can include any or some combination of a microprocessor, a core of a multi-core microprocessor, a microcontroller, a programmable integrated circuit, a programmable gate array, or another hardware processing circuit. Alternatively, a “controller” can refer to a combination of one or more hardware processing circuits and machine-readable instructions (software and/or firmware) executable on the one or more hardware processing circuits.

A storage medium (e.g., 300 in FIG. 3 or 404 in FIG. 4) can include any or some combination of the following: a semiconductor memory device such as a dynamic or static random access memory (a DRAM or SRAM), an erasable and programmable read-only memory (EPROM), an electrically erasable and programmable read-only memory (EEPROM), or a flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a system to:
as part of onboarding a tenant to a computing environment, generate a tenant identifier for the tenant;
add the tenant identifier to metadata of a management service for the computing environment;
track, with a metering service of the computing environment, metric data relating to resource usage by the tenant in the computing environment;
create, by the metering service, a resource usage record comprising attributes, the attributes comprising an attribute containing the metric data, and an attribute containing the tenant identifier;
correlate, by the management service, the tenant identifier in the metadata to the tenant identifier in the resource usage record; and
perform, with the management service, a management action for the tenant based on the resource usage record.

2. The non-transitory machine-readable storage medium of claim 1, wherein the computing environment is a disconnected cloud environment.

3. The non-transitory machine-readable storage medium of claim 1, wherein the management service is separate from the computing environment and does not interact directly with a tenant management controller of the computing environment.

4. The non-transitory machine-readable storage medium of claim 3, wherein the management service is provided by a first vendor that is different from a second vendor providing a computing environment platform deploying the computing environment.

5. The non-transitory machine-readable storage medium of claim 1, wherein the resource usage comprises usage of one or more virtual compute entities.

6. The non-transitory machine-readable storage medium of claim 1, wherein the resource usage comprises usage of one or more bare-metal servers.

7. The non-transitory machine-readable storage medium of claim 1, wherein the instructions upon execution cause the system to:
add the tenant identifier to the metadata of the management service after completion of a registration process to register the management service with a tenant management controller of the computing environment.

8. The non-transitory machine-readable storage medium of claim 1, wherein the management action comprises one or more selected from among:
capacity planning that determines how much resource capacity of the computing environment is to be assigned to the tenant,
resource allocation to dynamically increase or decrease resources of the computing environment for the tenant,
sprawl reduction to reduce a sprawl of virtual compute entities for the tenant, or
workload migration to move workloads across different physical resources in the computing environment.

9. The non-transitory machine-readable storage medium of claim 1, wherein the instructions upon execution cause the system to:
track, with the metering service of the computing environment, further metric data relating to resource usage by a further tenant in the computing environment;
create, by the metering service, a further resource usage record comprising attributes, the attributes of the further resource usage record comprising an attribute containing the further metric data, and an attribute containing a tenant identifier of the further tenant.

10. The non-transitory machine-readable storage medium of claim 1, wherein the resource usage record comprises time information identifying a time interval over which the metric data is collected.

11. The non-transitory machine-readable storage medium of claim 1, wherein the resource usage record comprises information indicating a type of a resource used by the tenant.

12. A system comprising:
a hardware processor; and
a non-transitory storage medium comprising instructions executable on the hardware processor to:
onboard a tenant to a computing environment;
generate a tenant identifier for the tenant as part of the onboarding;
add the tenant identifier to management metadata of a management service for the computing environment;
track metric data relating to resource usage by the tenant in the computing environment;
create a resource usage record comprising attributes, the attributes comprising an attribute containing the metric data, and an attribute containing the tenant identifier; and
provide the resource usage record to the management service for use by the management service in initiating a management action based on the tenant identifier added to the management metadata and the tenant identifier in the resource usage record.

13. The system of claim 12, wherein the instructions are executable on the hardware processor to:
provide an onboarding portal accessible by a user to request the onboarding of the tenant to the computing environment.

14. The system of claim 12, wherein the computing environment is a disconnected cloud environment.

15. The system of claim 12, wherein the instructions are executable on the hardware processor to:
track the metric data relating to the resource usage by the tenant in the computing environment during a metered time duration; and
add, to the resource usage record, time information indicating the metered time duration.

16. The system of claim 12, wherein the instructions are executable on the hardware processor to:
add, to the resource usage record, an attribute containing information indicating a type of resource used by the tenant.

17. The system of claim 16, wherein the resource usage record includes attributes containing metrics of features of the resource used by the tenant.

18. A method comprising:
onboarding, by a tenant management controller of a computing environment, tenants to the computing environment;
assigning, by the tenant management controller, tenant identifiers to the tenants as part of the onboarding;
adding, by the tenant management controller, the tenant identifiers to management metadata of a management service;
tracking, by a resource usage metering controller, resource usage of resources by the tenants;
creating, by the resource usage metering controller, resource usage records containing metric data for the resource usage of resources by the tenants, wherein each respective resource usage record of the resource usage records includes a tenant identifier identifying a tenant that the respective resource usage record is associated with; and
based on the tenant identifiers in the management metadata, performing, by the management service, tenant-specific management actions for the tenants based on the metric data in the resource usage records.

19. The method of claim 18, wherein the adding of the tenant identifiers to management metadata is after registration of the management service with the tenant management controller.

20. The method of claim 18, further comprising:
correlating, by the management service, the tenant identifiers in the management metadata to the tenant identifiers in the resource usage records as a prerequisite to performing the tenant-specific management actions.
